(19) United States
(12) Patent Application Publication
(10) Pub. No.: US 2021/0190173 A1
(43) Pub. Date: Jun. 24, 2021

(54) VIBRATION ABSORBER BUSH AND INNER TUBE ABSORBER HAVING SUCH A VIBRATION ABSORBER BUSH

(71) Applicant: Vibracoustic AG, Darmstadt (DE)

(72) Inventors: Erik Myklebust, Kongsberg (NO); Markus Dürre, Neuenburg am Rhein (DE)

(21) Appl. No.: 17/126,638

(22) Filed: Dec. 18, 2020

(30) Foreign Application Priority Data
Dec. 20, 2019 (DE) 102019135617.2

(51) Int. Cl. F16F 15/14; F16F 3/087

(52) U.S. Cl. CPC F16F 15/1442; F16F 3/0873; F16F 2234/02; F16F 2228/007; F16F 2232/02; F16F 2236/12; F16F 2222/08

(57) ABSTRACT

A vibration absorber bush for an inner tube absorber for absorbing torsional and flexural vibrations, for the coaxial assembly in a hollow shaft which is penetrated by a central longitudinal axis includes at least one largely cylindrical first elastic element and a largely cylindrical second elastic element which are in each case disposed to be coaxial with the longitudinal axis and to be mutually adjacent in the radial direction. In embodiments, a reinforcement element is disposed between the elastic elements.

### CROSS-REFERENCE TO RELATED APPLICATIONS

This application claims priority to German Patent Application No. DE 102019 135 617.2, filed Dec. 20, 2019, the contents of which are hereby incorporated by reference in its entirety.

### TECHNICAL FIELD

The invention relates to vibration absorber bushes and inner tube absorbers having such a vibration absorber bush.

### BACKGROUND

Inner tube absorbers which can be substantially rotationally symmetrical and able to be assembled so as to be coaxial in a hollow shaft are known. An inner tube absorber comprises at least one bush for holding the inner tube absorber in the hollow shaft, and at least one absorber mass which is held by the bush. The hollow shaft can be, for example, a drive shaft or a cardan shaft. A major field of application is in the sector of automotive technology where the inner tube absorbers minimize the inherent vibrations of shafts or tubes that are excited by a motor, by unbalances, or else by road surface unevenness, for example. The known inner tube absorbers by means of corresponding constructive modifications serve either for mainly absorbing torsional vibrations or mainly absorbing flexural vibrations. The modification for both types of vibrations has been very difficult to date. A high radial stiffness and at the same time a low torsional stiffness is in most instances the result to date in particular in the case of inner tube absorbers.

For the reduction of CO2 and for optimizing fuel consumption, many manufacturers of vehicles such as passenger motor vehicles or trucks typically use highly cascaded engines with cylinder deactivation, cylinder reduction (downsizing), or operate engines at the lowest possible revolutions (down-speeding). This however increases the level of low-frequency vibrations in the drive train that are undesirable.

Since the internal diameter of a hollow shaft, such as of a cardan shaft, for example, is small and the inert elements of the inner tube absorber can therefore also have only small diameters, inner tube absorbers known to date offer only a minor torsional inertia combined with a relatively high weight. However, neither the relatively minor absorption effect nor the high weight is desirable.

The inner tube absorbers should therefore have an ideally minor static unbalance. This however may require a maximum radial stiffness as a function of the torsion frequency to be absorbed. The inner tube absorbers should moreover have an ideally minor dynamic unbalance. A low frequency of the (cardanic) gyrating mode can lead to interfering reaction moments (dynamic unbalance).

### SUMMARY

A vibration absorber bush as well as an inner tube absorber having such a vibration absorber bush which overcome issues of the prior art are disclosed herein. Embodiments of the disclosed bushes and inner tube absorbers are in particular adapted or able to be adapted to the absorption of torsional vibrations as well as to the absorption of flexural vibrations, and may have an ideally minor static unbalance as well as an ideally minor dynamic unbalance.

The major features of the invention are disclosed herein. Design embodiments are also disclosed.

An embodiment of a vibration absorber bush for an inner tube absorber for absorbing torsional and flexural vibrations, for the coaxial assembly in a hollow shaft which is penetrated by a central longitudinal axis, comprises at least one largely cylindrical first elastic element and a largely cylindrical second elastic element which are in each case disposed so as to be coaxial with the longitudinal axis and so as to be mutually adjacent in the radial direction, wherein the reinforcement element is disposed between the elastic elements.

The bush as well as the hollow shaft may be penetrated by the same longitudinal axis. An elastic element may comprise that element which in the technical field of inner tube absorbers has the primary function of absorption. The elastic elements can be elastomer elements, for example. The hollow shaft can be a shaft of the vehicle, preferably a vehicle shaft which is installed in the longitudinal direction of the vehicle. “Assembly” is to be understood to be the installation of the inner tube absorber in the hollow shaft. “Joining” refers to the inner tube absorber being assembled from the individual components thereof.

Among other things, embodiments provide that a reinforcement element which decouples the two adjacent elastic elements from one another in such a manner that the deformation of the one elastic element has an ideally minor effect on the deformation of an adjacent elastic element is provided. Embodiments of the disclosed concepts offer the advantage that a radial stiffness of the bush is increased without substantially affecting an axial stiffness or a torsional stiffness, respectively. The deformation of the bush or of the elastic elements in the radial direction under forces acting thereon is significantly reduced, in particular on account of the increased radial stiffness.

In the event of a radial deflection of a previously known single, largely cylindrical, elastic element the free axial end faces are significantly cambered so as to compensate for the compression on the one hand (leading to the convexity) and the stretching on the other hand (leading to the concavity). This deformation of the axial end faces is greater the larger the surface of the axial free end faces. A torsional stress of the elastic element does however not lead to a camber of this type. By providing a reinforcement element according to the disclosed embodiments, the radial stiffness can be significantly increased by suppressing the camber (the axial end faces of each element are significantly reduced in size), but the torsional stiffness remains almost unchanged.

The reinforcement element can functionally separate the elastic elements from one another, on account of which a plurality of individual members are defined, the ratio between the free axial end face and the bearing surface of said individual members being smaller than the ratio of the previously known single elastic element. Functionally separating the elastic elements from one another means that, by means of a further component such as a covering, no noteworthy elongation, compression, and torsion is able to be transmitted between adjacent elastic elements and/or the main bodies of the adjacent elastic elements by means of the reinforcement element are not in direct physical contact. The main bodies in the axial direction can in each case terminate so as to be level with the reinforcement element. This can also not be excluded by a covering which covers the reinforcement element at least at one axial end and is connected to the two adjacent elastic elements.

The vibration absorber bush can be configured as a bush which conjointly with a further, preferably identical, vibration absorber bush, is suitable for supporting an absorber mass. In this case, one vibration absorber bush can in each case be disposed at both ends of the absorber mass so as to form one inner tube absorber. The vibration absorber bush can however also be configured as a bush which on its own supports an absorber mass so as to form one inner tube absorber. In this case, the absorber mass can centrally penetrate the bush, wherein the bush and the absorber mass can be mutually centred in the longitudinal direction.

The vibration absorber bush according to embodiments disclosed herein can thus be configured so as to be substantially stiffer in the radial direction, since the elastic elements can yield only to a minor extent and thus higher forces may be required for compressing the elastic elements. By means of the bush according to embodiments disclosed herein, an inner tube absorber can henceforth be tuned in such a manner that the torsion frequencies and bending frequencies to be absorbed lie at the resonance point of the inner tube absorber.

Embodiments of the disclosed concept are however not limited to the presence of two elastic elements which are separated by a reinforcement element. More elastic elements and more reinforcement elements are readily possible, wherein a reinforcement element is at best to be provided between two adjacent elastic elements.

The reinforcement element during an assembly of an inner tube absorber in the hollow shaft can also serve as a detent for an assembly tool, since the reinforcement element can be disposed centrally in the elastic region of the bush and distributes the thrust force introduced by the assembly tool in the best possible manner in the bush.

Moreover, the service life and thus the reliability of the bush may be increased on account of the reduced deformation of the axial end faces of the elastic elements.

According to a design embodiment of the vibration absorber bush, it is envisioned that the reinforcement element is a cylindrical reinforcement sleeve. Said cylindrical reinforcement sleeve, by means of this shape, may adapt itself to the shape of the adjacent elastic elements in the best possible manner. Said cylindrical reinforcement sleeve can moreover be configured such that said cylindrical reinforcement sleeve does not negatively influence the radial and torsional stiffness.

According to another design embodiment of the vibration absorber bush, the reinforcement element can be held exclusively by the elastic elements, and may preferably be surrounded by the elastic elements. In other words, in the radial direction one elastic element is disposed on both sides of the reinforcement element. Said reinforcement element is therefore released from other mountings and thus acts only on the adjacent elastic elements. The effect according to embodiments disclosed herein can be reinforced on account thereof.

According to a refinement of the vibration absorber bush, it is envisioned that said vibration absorber bush comprises an outer bearing sleeve which is disposed so as to be on the external circumference of that elastic element that is the outermost in terms of the radial direction. The bearing sleeve per se can be configured so as to be largely rigid and serve for linking the bush to the hollow shaft. The external bearing sleeve can at least in portions be circumferentially rubberized or sheathed with an elastomer, so as to provide a maximum axial press-fitting force in order to hold the inner tube absorber in the installed position thereof over the service life of the vehicle, for example. The installed position is understood to be the position of the inner tube absorber at a predefined position within the hollow shaft. The circumferential material can be, for example, a rubber shear coating which in terms of torsion is adapted for achieving the maximum cardanic stiffness (gyrating). The outer bearing sleeve can moreover serve as a radial deflection limitation for the absorber mass, specifically in that said outer bearing sleeve in the longitudinal direction at least in portions covers the absorber mass, and in the installed position there is a smaller spacing in the radial direction between the outer bearing sleeve (or optionally the surrounding material) and the absorber mass than in the radial direction between the absorber mass and the internal diameter of the hollow shaft. The circumferential face of the bush that in the installed position encompasses the outer bearing sleeve can serve as the reference dimension here too.

According to a further design embodiment of the vibration absorber bush, it is envisioned that said vibration absorber bush comprises an inner bearing sleeve which is disposed so as to be on the internal circumference of that elastic element that is the innermost in terms of the radial direction. The inner bearing sleeve per se can be configured so as to be largely rigid and serve for linking the bush to an absorber mass.

The outer bearing sleeve and/or the inner bearing sleeve can be advantageous in the case of high vibration loads since said loads can lead to disadvantageous stresses in the elastic elements. To the extent that the elastic elements are specifically configured as elastomers, a high load can be created on account of shrinkage by virtue of the elastic elements cooling after a high-temperature injection moulding operation. A mechanical effect on the elastic elements reduces the damaging stresses and can take place on account of the plastic deformation of at least one bearing sleeve. Alternatively or additionally, it is also envisioned for the reinforcement element to be embodied with a slot or slots.

The vibration absorber bush according to embodiments disclosed herein can also be refined in such a manner that the elastic elements are configured in such a manner that an elastic element has a shorter longitudinal extent in comparison to that elastic element that is directly adjacent and is more centrally disposed in terms of the radial direction. The flexural stiffness is able to be set by means of this aspect, since the elastic element that in radial terms lies further to the outside has a smaller lever and a larger circumference in comparison to the adjacent elastic element that is disposed further inward. The target variable can be the same stiffness in all or part of all elastic elements. The radial thickness of the elastic elements can be identical.

According to a refinement of the vibration absorber bush according to embodiments disclosed herein, it is also envisioned that at least one elastic element has at least one longitudinal cut-out. Longitudinal cut-outs serve for setting the stiffness of the respective elastic element in the case of a solid body, or an elastic element without longitudinal cut-outs, respectively, being excessively stiff. The stiffness of the vibration absorber bush can be set so as to be extremely stiff or extremely soft by means of the disposal of the longitudinal cut-outs in one elastic element and the longitudinal cut-outs in one further, preferably adjacent, elastic element. The vibration absorber bush has a hard response of behaviour in a radial direction which does not have any or only a few longitudinal cut-outs. The vibration absorber bush has a soft response of behaviour in a radial direction which has one or a plurality of optionally radially aligned longitudinal cut-outs. On account thereof, it is possible to achieve radial directions with a hard response of behaviour and radial directions with a soft response of behaviour in one single vibration absorber bush, the stiffness here can be spread in an extreme manner.

According to a further design embodiment of the vibration absorber bush according to embodiments disclosed herein, the longitudinal cut-outs of adjacent elastic elements can be disposed so as to be mutually offset in terms of the longitudinal axis. In the exemplary case of two elastic elements having in each case four uniformly spaced-apart longitudinal cut-outs, the longitudinal cut-outs of the adjacent elastic elements can be disposed so as to be mutually offset by 45°, for example. In this embodiment, the stiffness can be set so as to be identical in all radial directions.

A refinement of the vibration absorber bush according to embodiments disclosed herein can provide that the radial thickness of the elastic elements is identical, in particular approximately identical, or that the radial thickness of one elastic element is smaller than the radial thickness of an elastic element which is disposed so as to be directly adjacent and more central in terms of the radial direction. An identical twisting angle about the longitudinal axis between adjacent elastic elements can be set by means of the identical radial thicknesses, this leading to an extended service life.

Moreover, according to embodiments disclosed herein, is an inner tube absorber for the coaxial assembly in a hollow shaft, said inner tube absorber in the longitudinal direction thereof being penetrated by a central longitudinal axis and comprising at least one vibration absorber bush, such as disclosed herein, and including an absorber mass.

Advantages and features described with reference to the vibration absorber bush and the design embodiments thereof may be derived in analogous manner also for the inner tube absorber, reference being made to such advantages and features. With embodiments, an absorber mass should have a high torsional stiffness and/or said absorber mass can comprise steel, for example.

By virtue of the installation space which is becoming ever tighter and which is becoming increasingly short in supply for example on account of the increased installation space required for batteries of hybrid and fully electric vehicles, it has been demonstrated that an inner tube absorber according to embodiments disclosed herein having at least one vibration absorber bush according to embodiments disclosed herein as a radially and torsionally tuned absorber overcomes the issues of known inner tube absorbers.

In terms of the static unbalance, a maximum frequency split between the radial and the torsional resonance frequency is possible specifically by means of the vibration absorber bush wherein an ideally large radial frequency is preferred. In terms of the dynamic unbalance, a maximum frequency split between the radial and the cardanic resonance frequency is enabled by means of the vibration absorber bush, wherein an ideally large radial frequency is preferred.

According to a refinement of the inner tube absorber according to embodiments disclosed herein, one vibration absorber bush can in each case be disposed on both sides of the absorber mass, and/or the absorber mass can be configured so as to be cylindrical. On both sides means that one vibration absorber bush can in each case be disposed in the two distal end regions of the absorber mass which lie opposite one another along the longitudinal axis.

In terms of the dynamic unbalance, a maximum frequency split between the radial and the cardanic resonance frequency is enabled in particular by means of the two vibration absorber bushes. This can be achieved specifically by a cardanic stiffness which is as high as possible in that two vibration absorber bushes equipped with respective elastic elements are used at a maximum mutual spacing. This results in a significant leverage in terms of the cardanic moment.

The vibration absorber bushes disposed in such a manner moreover serve for reliably holding the absorber mass in the hollow shaft, and prevent the absorber mass impacting on the hollow shaft.

An inner tube absorber according to embodiments disclosed herein can also be refined in such a manner that the absorber mass can be configured as a solid-body absorber mass, or at least in portions can be configured as a hollow-body absorber mass. A solid-body absorber mass facilitates an assembly of the inner tube absorber, while a hollow-body absorber mass which has a central recess that runs along the longitudinal axis significantly lowers the weight of the inner tube absorber. Moreover, this recessed region has almost no effect in terms of torsional absorption.

According to a further design embodiment of the inner tube absorber according to embodiments disclosed herein, the absorber mass, alternatively or additionally to the mentioned design embodiments, can have adjacent portions of dissimilar diameters, on account of which a detent shoulder and a spacer shoulder can be configured. The absorber mass can thus have a stepped circumference. The adjacent portions can be disposed so as to be adjacent in the longitudinal direction. The shoulders can in each case have a surface which runs perpendicularly to the longitudinal axis. For example, a corresponding vibration absorber bush can permanently bear on the detent shoulder, specifically during and after the assembly. The spacer shoulder can be distinguished in that a spacing along the longitudinal axis is provided between the corresponding surface and the vibration absorber bush at least after the assembly. During the assembly, a compressive force on account of the bush being pressed-fitted can be introduced into the absorber mass by way of the shoulders. On the press-fitted bush at the opposite end of the absorber mass, at least one of the shoulders can serve for introducing the compressive force into the bush during the assembly and for pushing the bush further. In particular the spacer shoulder on the press-fitted bush contacts the bush on an impact face, and on account thereof prevents the press-fitted bush from stopping and being pushed onto the absorber mass.

An inner tube absorber according to embodiments disclosed herein can also be refined in such a manner that the at least one vibration absorber bush and/or the absorber mass are/is configured and/or disposed in such a manner that the ratio between the bending frequency to be absorbed and the torsion frequency to be absorbed is in the range between 10:9 and 10:1, may be in the range between 10:7 and 10:3, furthermore may be more than 10:5. A ratio of more than 3:2 is also envisioned. Frequency ratios of this type have specifically not been able to be absorbed to the desired extent using the previously known inner tube absorbers.

A refinement of the inner tube absorber according to embodiments disclosed herein can provide that the at least one vibration absorber bush and/or the absorber mass are/is configured and/or disposed in such a manner that the ratio between the overall length of the inner tube absorber along the longitudinal axis and the bush external diameter is at least 2.5. The overall length of the inner tube absorber can thus be at least 2½ times greater than the external diameter of the at least one vibration absorber bush. When using an inner tube absorber having two bushes it can be expedient to select a maximum spacing between the two bushes, which is a function of the specific installation situation, or else to select an optimal spacing taking into consideration the overall weight. On account thereof, the lever arm and the cardanic resonance frequency can be maximized and the dynamic unbalance can be minimized. The torsion vibrations are thus absorbed in the best possible manner.

According to a further design embodiment of the inner tube absorber according to embodiments disclosed herein, the at least one vibration absorber bush, alternatively or additionally to the mentioned design embodiments, can be configured and/or disposed in such a manner that the reinforcement element fulfils a radially stabilizing function in the event of the torsion frequency to be absorbed being at least 30% less than the bending frequency to be absorbed. The use of the reinforcement element according to embodiments disclosed herein can serve for adapting to the target frequencies to be absorbed specifically from this ratio upwards.

According to a refinement of the inner tube absorber according to embodiments disclosed herein, it is moreover envisioned that at least one holding means for fixing the absorber mass, preferably at least one delimitation ring which bears circumferentially on the absorber mass is disposed on the mass circumference of the absorber mass. The holding means can be disposed in one distal end region or both distal end regions of the absorber mass, and/or be disposed in the region of the largest diameter or circumference of the absorber mass. The holding means can prevent the absorber mass being released from the vibration absorber bush in the case of damage to the absorber mass and the latter tearing. Additionally or alternatively, said holding means can also prevent the absorber mass impacting on the internal wall of the hollow shaft. The holding means can be formed from an elastic material, preferably be an elastomer.

An assembly tool can be used for the assembly of the inner tube absorber in the hollow shaft which can be a shaft of a vehicle, preferably a vehicle longitudinal shaft which is installed in the longitudinal direction of the vehicle. The assembly tool for the coaxial assembly of an inner tube absorber according to the disclosed content of this application in a hollow shaft can comprise: a main body having a bush contact face for contacting the vibration absorber bush, as well as a mass contact face which for contacting the absorber mass is offset in the longitudinal direction in relation to the bush contact face, wherein the assembly tool is configured in such a manner that the two faces (bush contact face and mass contact face) during the assembly can simultaneously come into contact with the corresponding elements (vibration absorber bush and absorber mass) of the vibration absorber. The assembly tool is specifically designed in such a manner that a compressive force which emanates from the assembly tool can act simultaneously, and optionally in identical measures, on the vibration absorber bush and the absorber mass. Unnecessary stresses generated in the inner tube absorber are thus avoided.

Alternatively or additionally to the remainder of the disclosure of the application, but at least alternatively or additionally to the preceding paragraphs, the assembly tool can be designed in such a manner that the main body has a base portion and a protrusion portion of a smaller diameter which projects in relation to the base portion, wherein the base portion comprises the bush contact face, and the protrusion portion comprises the mass contact face.

Alternatively or additionally to the remainder of the disclosure of the application, but at least alternatively or additionally to the preceding paragraphs, the assembly tool can be designed in such a manner that the main body comprises a base portion and at least one pressure pin which is connected to the base portion and extends in the longitudinal direction, and which pressure pin is suitable for penetrating through an assembly recess in the vibration absorber bush and for contacting the absorber mass, wherein the base portion comprises the bush contact face, and the at least one pressure pin comprises the mass contact face.

Alternatively or additionally to the remainder of the disclosure of the application, but at least alternatively or additionally to the preceding paragraphs, the assembly tool can be designed in such a manner that the at least one pressure pin has a longitudinal extent that is larger than that of the vibration absorber bush.

An assembly method can be used for the assembly in the hollow shaft which can be a shaft of a vehicle, preferably a vehicle longitudinal shaft which is installed in the longitudinal direction of the vehicle. The method for the coaxial assembly of an inner tube absorber according to the disclosed content of this application in a hollow shaft can comprise the following steps:

providing a hollow shaft;

providing at least one inner tube absorber according to the disclosure;

providing an assembly tool according to the disclosure;

aligning the assembly tool, the inner tube absorber, and the hollow shaft so as to be mutually coaxial;

applying an axial compressive force, by means of the assembly tool, simultaneously to the vibration absorber bush that faces said assembly tool, as well as to the absorber mass;

on account thereof, pushing the inner tube absorber into the hollow shaft up to a predefined position within the hollow shaft.

Alternatively or additionally to the remainder of the disclosure of the application, but at least alternatively or additionally to the preceding paragraphs, the method can provide that, prior to applying the compressive force simultaneously to a compression face of the facing vibration absorber bush that faces the assembly tool, as well as to the absorber mass, the at least one mass contact face comes into contact with the absorber mass while a second longitudinal spacing is present between the facing vibration absorber bush, or the compression face thereof, respectively, and the bush contact face; and applying the compressive pressure leads to an axial spacing between the compression face and the bush contact face being shortened, and the second longitudinal spacing between the facing vibration absorber bush and the absorber mass being lengthened by the same measure until the bush contact face comes into contact with the compression face of the facing vibration absorber bush.

Alternatively or additionally to the remainder of the disclosure of the application, but at least alternatively or additionally to the preceding paragraphs, the method can provide:

providing two vibration absorber bushes, one on each end side of the absorber mass; and

retracting the assembly tool upon reaching the predefined position, on account of which no compressive force is any longer applied, on account of which the elasticity of the vibration absorber bushes leads to the absorber mass being centred so as to be centric between the vibration absorber bushes.

Moreover envisioned is the use of an inner tube absorber according to the disclosure of this application, but at least according to the preceding paragraphs, that is assembled coaxially in a hollow shaft for absorbing torsion vibrations and bending vibrations in a drive shaft or a cardan shaft. The shaft can be a longitudinal shaft.

### BRIEF DESCRIPTION OF THE DRAWINGS

Further features, details, and advantages of embodiments disclosed herein are derived from the wording of the claims as well as from the description hereunder of exemplary embodiments by means of the drawings in which:

FIG. 1 shows a lateral view of an inner tube absorber according to a first embodiment;

FIG. 2 shows a cross-sectional view along the line II-II in FIG. 1;

FIG. 3 shows an oblique view of the inner tube absorber according to FIG. 1;

FIG. 4 shows a lateral view of an inner tube absorber according to a second embodiment;

FIG. 5 shows a cross-sectional view along the line V-V in FIG. 4;

FIG. 6 shows an oblique view of the inner tube absorber according to FIG. 4;

FIG. 7 shows a lateral view of an inner tube absorber according to a third embodiment;

FIG. 8 shows a cross-sectional view along the line VIII-VIII in FIG. 7;

FIG. 9 shows an oblique view of the inner tube absorber according to FIG. 7;

FIG. 10 shows a lateral view of an inner tube absorber according to a fourth embodiment;

FIG. 11 shows a cross-sectional view along the line XI-XI in FIG. 10;

FIG. 12 shows an oblique view of the inner tube absorber according to FIG. 10;

FIG. 13 shows a lateral view of an inner tube absorber according to a fifth embodiment;

FIG. 14 shows a cross-sectional view along the line XIV-XIV in FIG. 13;

FIG. 15 shows an oblique view of the inner tube absorber according to FIG. 13;

FIG. 16 shows an assembly view of an inner tube absorber having a solid-body absorber mass; and

FIG. 17 shows an assembly view of an inner tube absorber having a hollow-body absorber mass.

The same or mutually equivalent elements are in each case identified by the same or similar reference signs in the figures and, unless expedient, are therefore not repeatedly described. The disclosures contained in the entire description can be applied in an analogous manner to identical parts with the same reference signs or the same component descriptions, respectively. Also, the positional indications chosen in the description, such as for example top, bottom, lateral, etc., relate to the figure which is directly described and illustrated and in the case of a change in the position are to be a applied in analogous manner to the new position. Furthermore, individual features or combinations of features from the different exemplary embodiments shown and described can also represent independent inventive solutions or solutions according to embodiments disclosed herein.

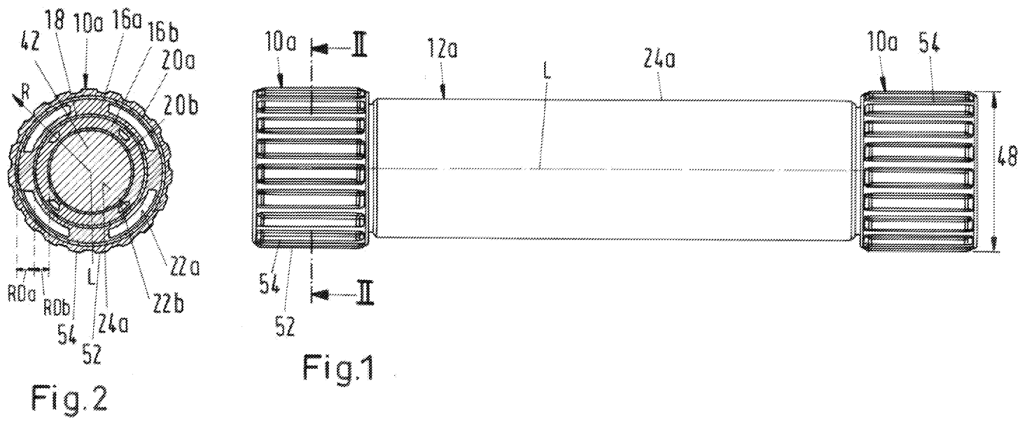

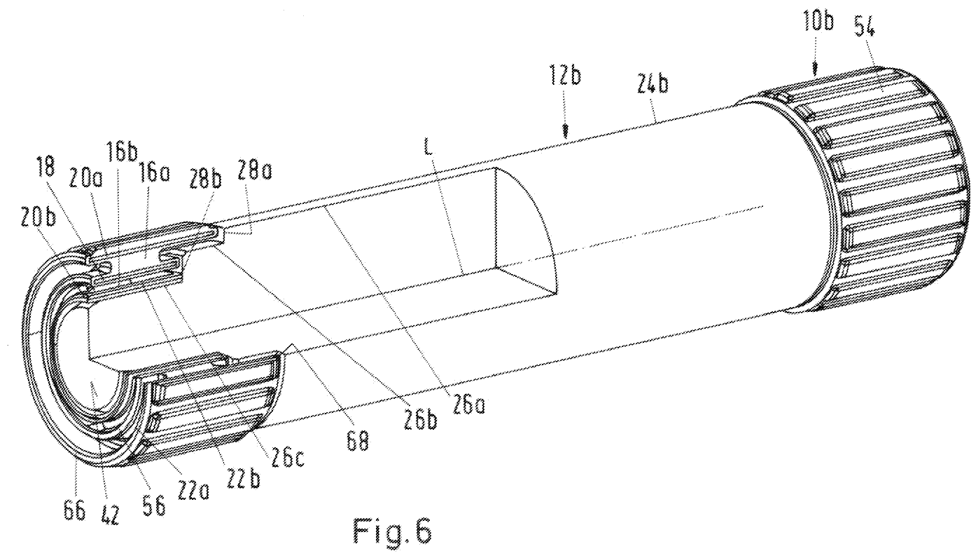

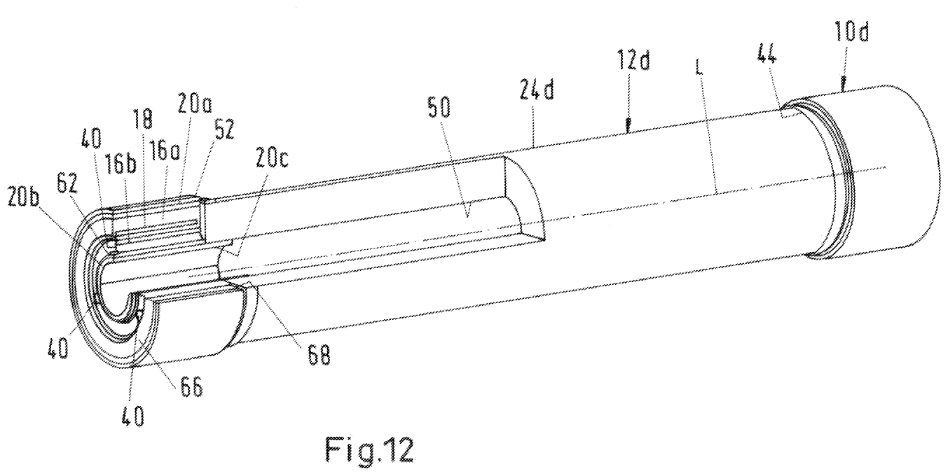

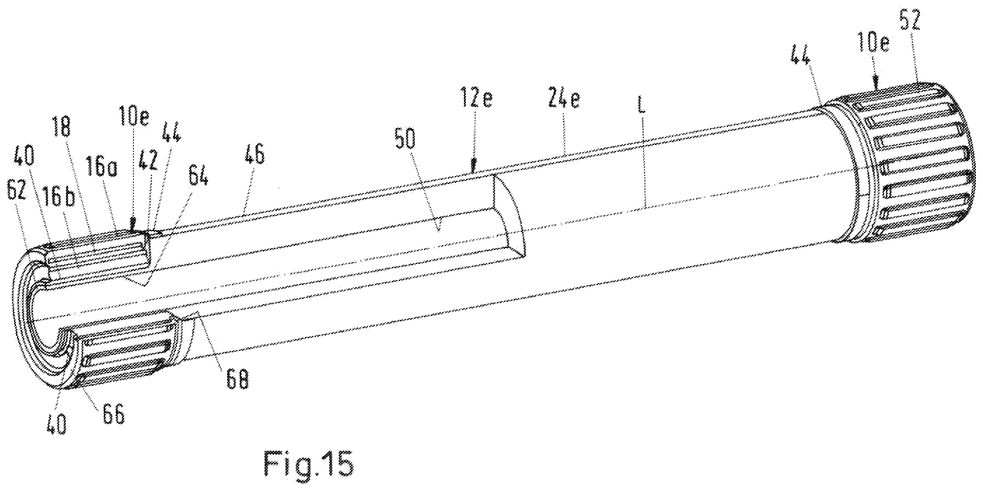

Five exemplary embodiments of inner tube absorbers 12a, 12b, 12c, 12d, and 12e are in each case shown by way of three figures in an assembled position (installed position) in FIGS. 1 to 15. The inner tube absorbers 12a, 12b, 12c, 12d, and 12e differ in each case in terms of various details which are to be explained with reference to the respective figures. The vibration absorber bushes shown in an exemplary embodiment are of identical configuration. Unless technically precluded, individual features of embodiments are to be considered as conjointly disclosed and capable of being combined with one another. Features which have already been described once are not to be described once again in order to avoid repetitions, even when said features are also illustrated in other figures. While inner tube absorbers having two bushes are shown in the figures, the features described therein are however also intended to be disclosed and claimed so as to apply to inner tube absorbers having only one bush.

### DETAILED DESCRIPTION

FIG. 1 shows an inner tube absorber 12a according to a first embodiment, said inner tube absorber 12a being configured so as to be substantially rotationally symmetrical to a longitudinal axis L. An absorber mass 24a is disposed in a radially inward manner. The absorber mass 24a has a rotationally symmetrical cylindrical basic shape having end sides 42, said cylindrical basic shape being free of any unbalance in terms of a rotating movement about the longitudinal axis L. The absorber mass 24a can also be surrounded by an external sleeve which is likewise preferably free of any unbalance and has a hollow cylindrical basic shape and a casing from an elastomer.

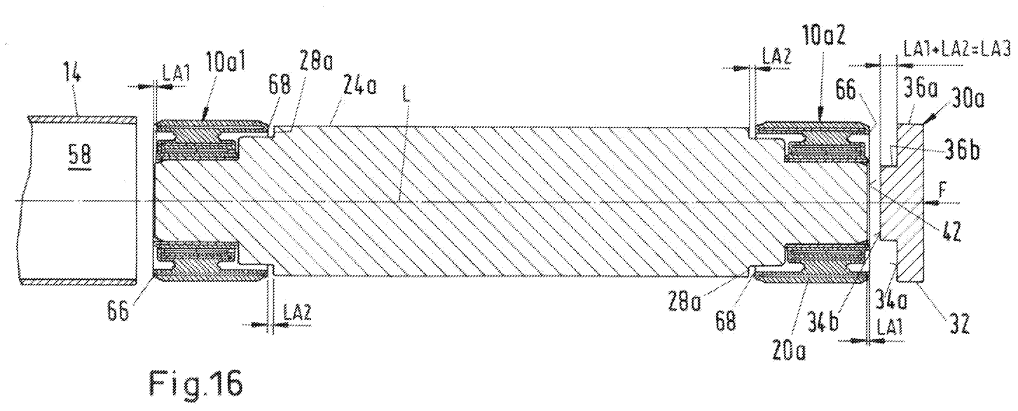

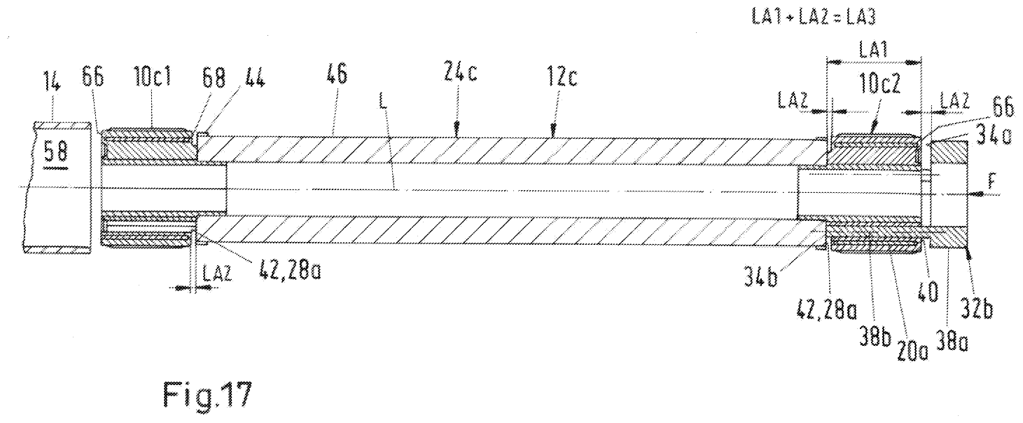

The inner tube absorber 12a serves for the coaxial assembly in a hollow shaft 14 which in FIG. 16 is shown in an exemplary manner in the context of an assembly view. The inner tube absorber 12a comprises the absorber mass 24a which is configured as a solid-body absorber mass, and two vibration absorber bushes 10a of identical configuration. Each vibration absorber bush 10a in one of the two distal end regions is connected, preferably press-fitted, to the absorber mass 24a.

Each of the two vibration absorber bushes 10a on the circumference has a casing 52 of elastomer. The vibration absorber bushes 10a have a sufficient stiffness such that the inner tube absorber 12a can be permanently fastened in a hollow shaft by way of a press-fit. The casing 52 has studs 54 which are disposed on the circumference and protrude radially outwards from the external circumferential face of the casing 52, and by means of which a production tolerance of the internal diameter of the hollow shaft 14 can be compensated for. The studs 54 are disposed so as to be uniformly spaced apart from one another in the circumferential direction and are distributed across the entire external circumferential face of the casing 52. The studs 54 have an elongate main body which extends parallel to the longitudinal axis L. The studs 54 are compressed when being press-fitted into the hollow shaft 14. A compression face 66 is identified for press-fitting and contacting an assembly tool. Said compression face 66 can be that location of the vibration absorber bush 10a that is the most exposed in the longitudinal direction. The bush 10a at the end facing the absorber mass 24a has an impact face 68 by way of which said bush 10a during the assembly can impact the absorber mass 24a in order for compressive forces to be introduced or for compressive forces to be received.

As is shown in FIG. 2, each of the two vibration absorber bushes 10a is likewise centrally penetrated by the longitudinal axis L, and comprises a cylindrical first elastic element 16a having a main body which has a radial thickness RDa, and a cylindrical second elastic element 16b having a main body which has a radial thickness RDb. RDa and RDb are presently of identical size. The elastic elements 16a, 16b are in each case aligned so as to be coaxial with the longitudinal axis L and are disposed so as to be mutually adjacent in the radial direction R. The main bodies of the elastic elements 16a, 16b in the axial direction terminate in each case so as to be level with the reinforcement element 18. The two elastic elements 16a, 16b therefore have dissimilar diameters, wherein the respective outer first elastic element 16a encompasses the inner second elastic element 16b. A reinforcement element 18 in the form of a cylindrical reinforcement sleeve is disposed between the two elastic elements 16a, 16b in such a manner that said reinforcement element 18 mutually separates the adjacent elastic elements 16a, 16b.

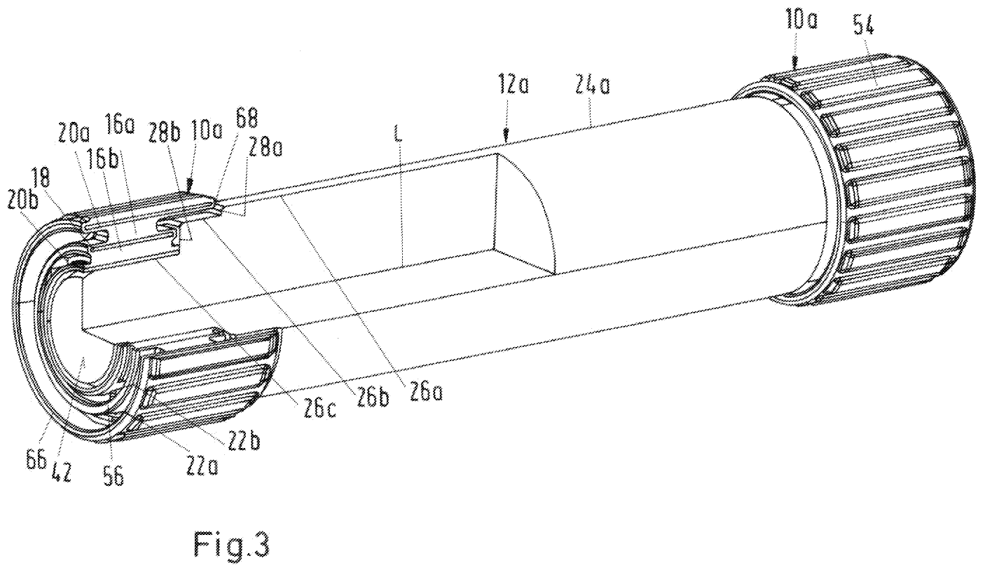

FIG. 3 shows in particular that the reinforcement element 18 is held exclusively by the elastic elements 16a, 16b and in the radial direction R is surrounded by the elastic elements 16a, 16b. The reinforcement element 18 on both axial sides thereof can be provided with a covering 56 which can also cover the two elastic elements 16a, 16b, this however not leading to the elastic elements 16a, 16b being connected as opposed to the concept of embodiments disclosed herein. Despite the covering 56, the reinforcement element 18 in functional terms specifically separates the elastic elements 16a, 16b, or the main bodies thereof, from one another. The covering 56 does not transmit any noteworthy elongation, compression, and torsion between adjacent elastic elements 16a, 16b. A covering 56 can also result from the reinforcement element 18 being placed into a mould and subsequently being overmoulded with an elastic material, preferably an elastomer, at least in portions in order for the elastic elements 16a, 16b to be configured. The elastic elements 16a, 16b then remain functionally separated. The covering can also cover at least in portions bearing sleeves 20a, 20b.

The vibration absorber bushes 10a also comprise an outer bearing sleeve 20a which is disposed on the external circumference of the outermost elastic element 16a, as well as an inner bearing sleeve 20b which is disposed on the inner circumference of the innermost elastic element 16b. The bearing sleeves are configured so as to be cylindrical. The outer bearing sleeve 20a supports the casing 52 including the studs 54 and serves as a support in relation to an internal circumferential face 58 of the hollow tube 14.

Each of the two elastic elements 16a, 16b has four uniformly spaced-apart longitudinal cut-outs 22a, 22b which are mutually aligned in the radial direction R, or are disposed so as to be mutually offset by an angle of 0° in relation to the longitudinal axis L—an extreme spread of stiffness is present within the elastic elements 16a, 16b. In terms of the image plane of FIG. 2, the elastic elements 16a, 16b are specifically extremely hard in the horizontal and vertical direction (by virtue of the material present) and are extremely soft in a region which is tilted by 45° in relation thereto (by virtue of the aligned longitudinal cut-outs 22a, 22b). The outer longitudinal cut-outs 22a occupy a larger segment than the longitudinal cut-outs 22b, on account of which the inner longitudinal cut-outs 22b are completely covered by the outer longitudinal cut-outs 22a. An overall spread of the stiffness can be achieved across 360° (in terms of the cross section) on account of this alignment of the longitudinal cut-outs 22a, 22b. The elastic elements 16a, 16b are moreover configured in such a manner that the first elastic element 16a has a shorter longitudinal extent in comparison to the directly adjacent second elastic element 16b which is disposed so as to be more central in terms of the radial direction R. The two elastic elements 16a, 16b are however mutually centred in the longitudinal direction.

The connection between the vibration absorber bushes 10a and the absorber mass 24a is now to be described by means of FIG. 3. The absorber mass 24a along the longitudinal axis L has adjacent portions 26a, 26b, 26c of dissimilar diameters. On account thereof, a spacer shoulder 28a which in the longitudinal direction has a spacing from the outer bearing sleeve 20a is configured between the portions 26a and 26b. A detent shoulder 28b on which the inner bearing sleeve 20b impacts, or on which the latter bears, is thus configured between the portions 26a and 26b. There is also a spacing between the detent shoulder 28b and the reinforcement element 18. The external diameter of the portion 26c in relation to the internal diameter of the inner bearing sleeve 20b is dimensioned such that a permanent press-fit can be implemented between these two elements. The vibration absorber bushes 10a are thus press-fitted to the absorber mass 24a. On account of the vibration absorber bush 10a been present on both distal ends of the absorber mass 24a, the absorber mass 24a is fixed in the longitudinal direction L, in the radial direction R, and in the circumferential direction. The outer bearing sleeve 20a proximal to the absorber mass is lengthened and at least partially covers the portion 26c, wherein a radial spacing is present therebetween. It is envisioned that the ratio between the overall length of the inner tube absorber 12a, or the absorber length 60, respectively, along the longitudinal axis L and the bush external diameter 48 is at least 2.5. The cardanic resonance frequency can be increased, for example, by two vibration absorber bushes having a maximum radial stiffness and a maximum axial spacing.

It is advantageous for the bush 10a and/or the absorber mass 24a to be configured and/or disposed in such a manner that a radial space between the circumferential portion of the absorber mass 24a (here the portion 26b) and the outer bearing sleeve 20a has a radial length that is smaller than a radial space between the circumference 46 of the absorber mass 24a and the internal circumferential face 58 of the hollow shaft 14 (or the external circumferential face of the bearing sleeve 20a, optionally minus the length which is created on account of the compression when assembling). On account thereof, the outer bearing sleeve 20a which is preferably encompassed by an elastomer serves as a radial deflection delimitation for the absorber mass 24a. If the absorber mass were to specifically deflect in the radial direction, said absorber mass only impacts the outer bearing sleeve 20a and not the internal circumferential face 58 of the hollow shaft 14. This prevents unintentional noises and significantly increases the service life of the absorber mass and the hollow shaft.

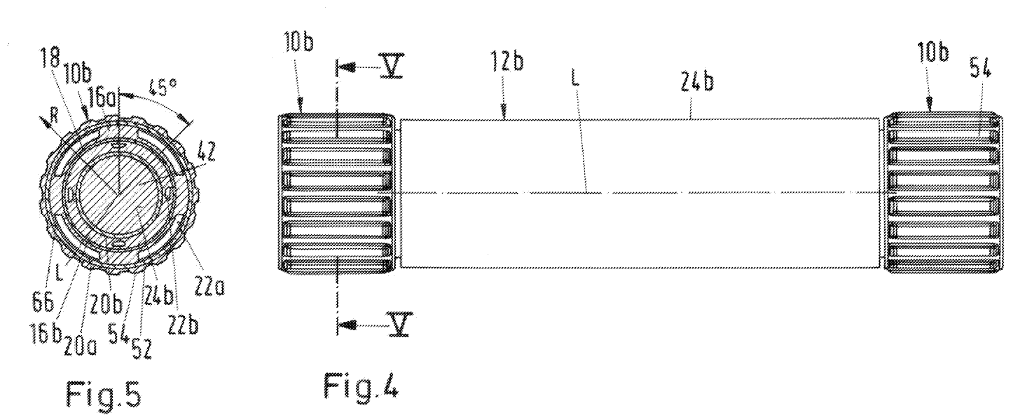

A second embodiment of an inner tube absorber 12b is to be described hereunder with reference to FIGS. 4 to 6, wherein only the points of differentiation in comparison the first embodiment are to be substantially discussed here.

The inner tube absorber 12b is penetrated by the longitudinal axis L and comprises an absorber mass 24a and two vibration absorber bushes 10b which are disposed at both ends of the absorber mass 24b. The elastic elements 16a and 16b furthermore have in each case four longitudinal cut-outs 22a, 22b, but the inner, or second, longitudinal cut-outs 22b in relation to the outer, or first, longitudinal cut-outs 22a are disposed so as to be offset at an angle of 45° in terms of the longitudinal axis L—there is an extreme equality of stiffness within the elastic elements 16a, 16b.

In terms of the image plane of FIG. 5, the elastic elements 16a, 16b are specifically set to the same hardness in the horizontal direction, in the vertical direction, and in a direction which is tilted by 45° in relation thereto (by virtue of the material present and by virtue of the longitudinal cut-outs 22a, 22b which in relation to the longitudinal axis are distributed across the circumference). An overall stiffness uniformity across 360° (in terms of the cross section) can be implemented on account of this mutual radial offset of the longitudinal cut-outs 22a, 22b.

The absorber mass 24b along the longitudinal axis L has adjacent portions 26a, 26b, 26c of dissimilar diameters, wherein the diameter of the portion 26a is enlarged in comparison to the first embodiment. The outer bearing sleeve 20a by way of the impact face 68 thereof herein can be pushed onto the likewise enlarged spacer shoulder 28a during the assembly, and a compressive force can thus also be introduced into the circumferential region of the absorber mass 24b, or be received from there.

The outer bearing sleeve 20a moreover serves as a radial deflection delimitation for the absorber mass 24a, specifically in that said outer bearing sleeve 20a at least in portions covers the absorber mass 24b in the longitudinal direction. Moreover, in the radial direction between the outer bearing sleeve 20a (or optionally the surrounding material) and the absorber mass 24b (here the portion 26b), there is a smaller radial spacing than in the radial direction between the absorber mass 24b (here the portion 26a, since the latter has the largest diameter) and the internal diameter of the hollow shaft 14. Alternatively, the radial spacing from the circumferential face of the bush 10b in the installed state can also serve as a reference.

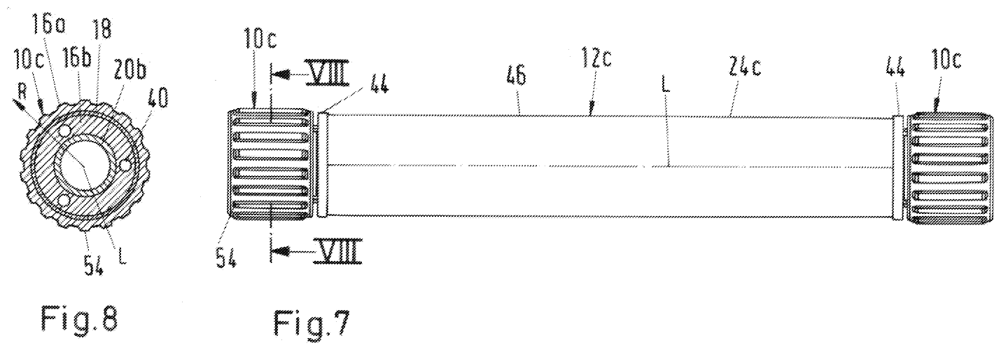

A third embodiment of an inner tube absorber 12c is to be described hereunder with reference to FIGS. 7 to 9, wherein only the points of differentiation in comparison to the first embodiment are to be substantially discussed here.

The inner tube absorber 12c is penetrated by the longitudinal axis L and comprises an absorber mass 24c and two vibration absorber bushes 10c which are disposed at both ends of the absorber mass 24c. Two delimitation rings 44 which for fixing the absorber mass 24c bear circumferentially on the absorber mass 24c are disposed on the mass circumference 46 of the absorber mass 24c. The delimitation rings 44 in the axial direction terminate at the end side 42 of the absorber mass 24c.

Each vibration absorber bush 10c henceforth no longer comprises any outer bearing sleeve 26a. On account thereof, the first elastic element 16a forms a circumferential external region and therefore also comprises the studs 54 in the same manner as described above. A press-fit with the hollow shaft 14 therefore may require sufficient friction between the studs 54 and the internal circumferential face 58.

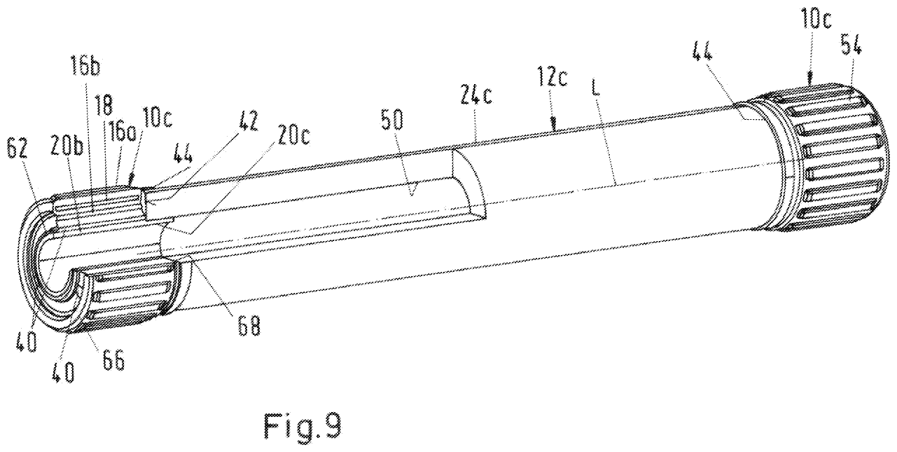

FIG. 9 shows that the absorber mass 24c is configured as a hollow-body absorber mass which has a longitudinally continuous central recess 50. On account of the absorber mass 24c being hollow at least in the distal end regions thereof, the vibration absorber bush is no longer press-fitted onto a portion of the absorber mass but press-fitted into said absorber mass. To this end, the vibration absorber bush 10c has an inner bearing sleeve 20b having a absorber-mass-proximal extension portion 20c which engages in the central recess 50 so as to establish a press-fit with the vibration absorber bush 10c. A support portion 62 which is embodied so as to be cylindrical and can be formed from the material of the elastic element 16b is provided between the inner bearing sleeve 20b and the second elastic element 16b. The support portion 62 in the axial direction at the end proximal to the absorber mass terminates at the inner bearing sleeve 20b and proximal to the absorber mass bears on the end face 42. On account thereof, the vibration absorber bush 10c is supported in relation to the absorber mass 24c. An axial spacing is present between the end face 42, on the one hand, and the two elastic elements 16a, 16b as well as the reinforcement element 18, on the other hand.

The vibration absorber bushes 10c have in each case three uniformly spaced-apart assembly recesses 40 which penetrate the vibration absorber bushes 10c in the longitudinal direction. As will yet be described with reference to FIG. 17, these assembly recesses 40 serve for the penetration by an assembly tool 30b and, on account thereof, the direct introduction of a compressive F into the absorber mass 24c.

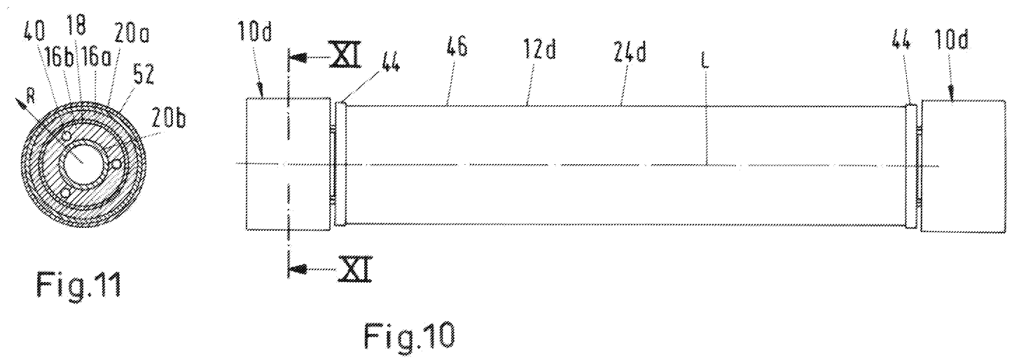

A fourth embodiment of an inner tube absorber 12d is to be described hereunder with reference to FIGS. 10 to 12, wherein only the points of differentiation in comparison to the first embodiment are to be substantially discussed here.

The tube absorber 12d is penetrated by the longitudinal axis L and comprises an absorber mass 24d and two vibration absorber bushes 10d which are disposed at both ends of the absorber mass 24d. The absorber mass 24d is configured as a hollow-body absorber mass, and the vibration absorber bush 10d has the outer bearing sleeve 20a which supports the casing 52, however without studs 54 and thus without any elastic or elastomeric press-fit within the hollow shaft 14.

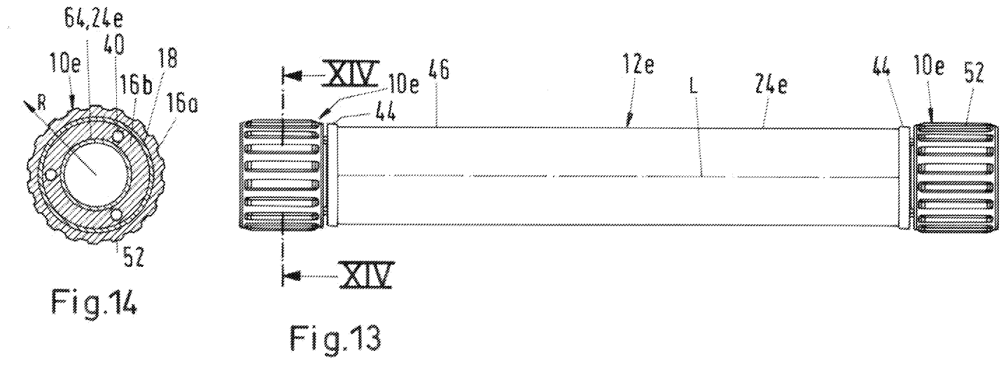

A fifth embodiment of an inner tube absorber 12e is to be described hereunder with reference to FIGS. 13 to 15, wherein only the points of differentiation in comparison to the first embodiment are to be substantially discussed here.

The inner tube absorber 12e is penetrated by the longitudinal axis L and comprises an absorber mass 24e and two vibration absorber bushes 10e which are disposed at both ends of the absorber mass 24e.

Each vibration absorber bush 10e no longer comprises any outer bearing sleeve 26a and also no inner bearing sleeve 26b. On account thereof, the first elastic element 16a forms a circumferential external region and therefore also comprises the studs 54 in the same manner as described above. Since the vibration absorber bushes 10e now no longer comprise any inner bearing sleeve 20b, the absorber mass 24e has an extension portion 64. The respective vibration absorber bush 10e is disposed by way of a press-fit on this extension portion 64.

An assembly of the inner tube absorber 12a is shown in FIG. 16, wherein such an assembly takes place in the same or a similar manner for each inner tube absorber 12a, 12b which has an absorber mass 24a, 24b which has a sufficiently large axial face which can be directly contacted by an assembly tool. This in most instances applies to solid-body absorber masses. The inner tube absorber 12a comprises already-described vibration absorber bushes 10a wherein the latter for improved clarity hereinafter are to be referred to as the vibration absorber bush 10a1 (indented vibration absorber bush) and the vibration absorber bush 10a2 (indenting vibration absorber bush).

An assembly tool 30a for assembling the inner tube absorber 12a in a coaxial manner in a hollow shaft 14 is used for this assembly. The assembly tool 30a comprises a cylindrical main body 32a having a circular bush contact face 34a for contacting the vibration absorber bush 10a2, as well as a mass contact face 34b which for contacting the absorber mass 24a is offset in the longitudinal direction in relation to the bush contact face 34a. The vibration absorber bush 10a2, proximal to the assembly tool, before and after the assembly protrudes by the dimension LA1 (first longitudinal spacing) from the end side 42 of the absorber mass 24a. A spacing dimension LA2 (second longitudinal spacing) is present before and after the assembly on the opposite side between the vibration absorber bush 10a2 in the region of the outer bearing sleeve 20a, or the impact face 68, respectively, and the spacer shoulder 28a. The mass contact face 34b in the direction of the inner tube absorber 10a2 is now offset by the sum of these two dimensions LA1 and LA2 in relation to the bush contact face 34a, referred to as LA3 (third longitudinal spacing), where: LA1+LA2=LA3. Prior to the assembly, there thus exists a direct correlation between the dimensions of the bush/the absorber and the tool.

More specifically, the main body 32a has a base portion 36a and a protrusion portion 36b of a smaller diameter which projects in relation to the base portion 36a, wherein the base portion 36a comprises the bush contact face 34a, and the protrusion portion 36b comprises the mass contact face 34b.

The assembly method for the inner tube absorber 12a shown now provides that first the hollow shaft 14, the inner tube absorber 12a, and the assembly tool 30a are provided. The assembly tool 30a, the inner tube absorber 12a, and the hollow shaft 14 are thereafter aligned so as to be mutually coaxial, as is shown in FIG. 16. An axial compressive force F is then applied by means of the assembly tool 30a. On account thereof, the mass contact face 34b comes into contact with the absorber mass 24a, while the second longitudinal spacing LA2 is present between the facing (facing the assembly tool) vibration absorber bush 10a2, or the compression face 66 thereof, respectively, and the bush contact face 34a, and applying the compressive force F leads to an axial spacing between the compression face 66 and the bush contact face 34a being shortened, and the second longitudinal spacing LA2 between the facing vibration absorber bush 10a2, or the impact face 68, respectively, and the absorber mass 24a, or the shoulder 28a, respectively, being lengthened by the same measure until the bush contact face 34a comes into contact with the compression face 66 of the facing vibration absorber bush 10a2.

Thereafter, the facing vibration absorber bush 10a2 as well as the absorber mass 24a can be likewise axially displaced, this leading to the second longitudinal spacing LA2 at the indented vibration absorber bush 10a1 being reduced to zero, and the absorber mass 24a impacting the impact face 68 of the indented vibration absorber bush 10al, and thus also displacing the vibration absorber bush 10al. On account thereof, the inner tube absorber 12a is pushed into the hollow shaft 14 up to a predefined position (not shown) within the hollow shaft 14.

The assembly tool 30a is retracted upon reaching this position, on account of which no compressive force F is applied any longer, on account of which the elasticity of the vibration absorber bushes 10a1 and 10a2 leads to the absorber mass 24a being centred so as to be centric between the vibration absorber bushes 10a1 and 10a2. Likewise, the first longitudinal spacings LA1 and the second longitudinal spacings LA2 reassume their dimensions prior to the assembly.

An assembly of the inner tube absorber 12c is shown in FIG. 17, wherein such an assembly takes place in the same or a similar manner for each inner tube absorber 12c, 12d, 12e which has an absorber mass 24c, 24d, 24e which on the end side of the absorber does not have a sufficiently large axial face which can be directly contacted by an assembly tool. This applies in most instances to absorber masses which are hollow at least in distal end regions. The inner tube absorber 12c comprises two already-described vibration absorber bushes 10c, wherein the latter for improved clarity hereinafter are to be referred to as the vibration absorber bush 10c1 (indented vibration absorber bush) and the vibration absorber bush 10c2 (indenting vibration absorber bush).

An assembly tool 30b for assembling the inner tube absorber 12c so as to be coaxial in a hollow shaft 14 is used for this assembly. The assembly tool 30b comprises a cylindrical main body 32b having a circular bush contact face 34a for contacting the vibration absorber bush 10c2 on a compression face 66, as well as the mass contact face 34b which for contacting the absorber mass 24c is offset in the longitudinal direction in relation to the bush contact face 34a. The vibration absorber bush 10c2, proximal to the assembly tool, before and after the assembly protrudes by the dimension LA1 (first longitudinal spacing) from the end side 42 of the absorber mass 24a. A spacing dimension LA2 (second longitudinal spacing) is present on the side of the vibration absorber bush 10c2 that is opposite the assembly tool 30b, between the vibration absorber bush 10c2 in the region of the outer bearing sleeve 20a and the spacer shoulder 28a. The end side 42 can also configure the spacer shoulder 28a. The mass contact face 34b in the direction of the inner tube absorber 10c2 is now offset by the sum of these two dimensions LA1 and LA2 in relation to the bush contact face 34a, referred to as LA3 (third longitudinal spacing), where: LA1+LA2=LA3. Prior to the assembly, there thus exists a direct correlation between the dimensions of the bush/the absorber and the tool.

More specifically, the main body 32b has a base portion 38a and at least one pressure pin 38b which is connected to the base portion 38a and extends in the longitudinal direction, and which pressure pin 38b is suitable for penetrating through a corresponding assembly recess 40 in the vibration absorber bush 10c2 and for contacting the absorber mass 24c, preferably on the end side 42 thereof. The base portion 38a comprises the bush contact face 34a, and the at least one pressure pin 38b comprises the mass contact face 34b. The at least one pressure pin 38b can have a greater longitudinal extent than the vibration absorber bush 10c1/10c2. The dimension of this larger longitudinal extent of the pressure pin 38b likewise has the spacing dimension LA2 (second longitudinal spacing).

The assembly method for the inner tube absorber 12c shown now provides that first the hollow shaft 14, the inner tube absorber 12c, and the assembly tool 30b are provided. The assembly tool 30b, the inner tube absorber 12c, and the hollow shaft 14 are thereafter aligned so as to be mutually coaxial, as is shown in FIG. 17. The pressure pins 38b penetrate the assembly recesses 40. An axial compressive force F is then applied by means of the assembly tool 30b. On account thereof, the mass contact face 34b comes into contact with the absorber mass 24c, while the second longitudinal spacing LA2 is present between the facing (facing the assembly tool) vibration absorber bush 10c2, or the compression face 66 thereof, respectively, and the bush contact face 34a, and applying the compressive force F leads to an axial spacing between the compression face 66 and the bush contact face 34a being shortened, and the second longitudinal spacing LA2 between the facing vibration absorber bush 10c2 and the absorber mass 24c being lengthened by the same measure until the bush contact face 34a comes into contact with the compression face 66 of the facing vibration absorber bush 10c2.

Thereafter, the facing vibration absorber bush 10c2 as well as the absorber mass 24c can be likewise axially displaced, this leading to the second longitudinal spacing LA2 at the vibration absorber bush 10c1 being reduced to zero and the absorber mass 24c impacting an impact face 68 of the vibration absorber bush 10c1 and thus also displacing the vibration absorber bush 10c1. On account thereof, the inner tube absorber 12c is pushed into the hollow shaft 14 up to a predefined position (not shown) within the hollow shaft 14.

The assembly tool 30b is retracted upon reaching this position, on account of which no compressive force F is any longer applied, on account of which the elasticity of the vibration absorber bushes 10c1 and 10c2 leads to the absorber mass 24c being centred so as to be centric between the vibration absorber bushes 10c1 and 10c2. Likewise, the second longitudinal spacings LA2 reassume their dimensions prior to the assembly.

The disclosure is not limited to any of the afore-described embodiments but can be modified in many ways. All of the features and advantages, including constructive details, spatial arrangements, and method steps, that are derived from the claims, the description, and the drawing can be relevant to the disclosure individually as well as in the most varied combinations.

All combinations of at least two features disclosed in the description, the claims and/or the figures are included in the scope of the invention as defined by the claims.

In order to avoid repetitions, features which have been disclosed in the context of the device are to be considered disclosed and claimed in the context of the method. Likewise, features disclosed in the context of the method are to be considered disclosed and claimed in the context of the device.

1. A vibration absorber bush for an inner tube absorber for absorbing torsional and flexural vibrations, for coaxial assembly in a hollow shaft which is penetrated by a central longitudinal axis, comprising: at least one largely cylindrical first elastic element and a largely cylindrical second elastic element which are in each case disposed to be coaxial with the longitudinal axis and to be mutually adjacent in the radial direction, and including a reinforcement element disposed between the first and second elastic elements.

2. The vibration absorber bush according to claim 1, wherein the reinforcement element is held exclusively by the first and second elastic elements.

3. The vibration absorber bush according to claim 1, wherein the reinforcement element is held exclusively by the first and second elastic elements and is surrounded by the first and second elastic elements.

4. The vibration absorber bush according to claim 1, wherein said vibration absorber bush comprises an outer bearing sleeve disposed on an external circumference of the first elastic element that is the outermost in terms of the radial direction.

5. The vibration absorber bush according to claim 1, wherein said vibration absorber bush comprises an inner bearing sleeve disposed on an internal circumference of the second elastic element that is the innermost in terms of the radial direction.

6. The vibration absorber bush according to claim 1, wherein said vibration absorber bush comprises an outer bearing sleeve disposed on an external circumference of the first elastic element that is the outermost in terms of the radial direction; and said vibration absorber bush comprises an inner bearing sleeve disposed on an internal circumference of the second elastic element that is the innermost in terms of the radial direction.

7. The vibration absorber bush according to claim 1, wherein the first and second elastic elements are configured such that the first elastic element has a shorter longitudinal extent in comparison to the second elastic element that is directly adjacent and is more centrally disposed in terms of the radial direction.

8. The vibration absorber bush according to claim 1, wherein at least one of the first elastic element and the second elastic element has at least one longitudinal cut-out.

9. The absorber bush according to claim 1, wherein the first elastic element and the second elastic element each have a longitudinal cut-out, and the longitudinal cut-outs of adjacent first and second elastic elements are disposed to be mutually offset in the circumferential direction.

10. An inner tube absorber for a coaxial assembly in a hollow shaft, said inner tube absorber in the longitudinal direction thereof being penetrated by a central longitudinal axis, comprising at least one vibration absorber bush according to claim 1 and including an absorber mass.

11. The inner tube absorber according to claim 10, wherein the at least one vibration absorber bush and/or the absorber mass is configured and/or disposed such that a ratio between the bending frequency to be absorbed and the torsion frequency to be absorbed is in the range between 10:9 and 10:1.

12. The inner tube absorber according to claim 10, wherein the at least one vibration absorber bush and/or the absorber mass is configured and/or disposed such that a ratio between the bending frequency to be absorbed and the torsion frequency to be absorbed is in the range between 10:7 and 10:3.

13. The inner tube absorber according to claim 10, wherein the at least one vibration absorber bush and/or the absorber mass is configured and/or disposed such that a ratio between the bending frequency to be absorbed and the torsion frequency to be absorbed is more than 10:5.

14. The inner tube absorber according to claim 10, wherein the at least one vibration absorber bush and/or the absorber mass is configured and/or disposed such that the ratio between the overall length of the inner tube absorber along the longitudinal axis and the bush external diameter is at least 2.5.
